(19) United States
(12) Patent Application Publication
(10) Pub. No.: US 2008/0092178 A1
(43) Pub. Date: Apr. 17, 2008

(54) Streaming video

(75) Inventors: Justin Michael McNamara, Atlanta, GA (US); Jeffrey Clinton Mikan, Cumming, GA (US)

Correspondence Address: MOAZZAM & ASSOCIATES, LLC;MATTERS FOR CINGULAR WIRELESS II, LLC, 7601 LEWINSVILLE ROAD, SUITE 304, MCLEAN, VA, 22102, US

(73) Assignee: Cingular Wireless II, LLC

(21) Appl. No.: 11/545,599

(22) Filed: Oct. 11, 2006

(51) Int. Cl. H04N 7/16

(52) U.S. Cl. 725/62; 725/135

(57) ABSTRACT

A system for streaming video is disclosed. A requesting device transmits a streaming video request to an intermediate server. The intermediate server sends a WAP Push to a receiving device. The receiving device may accept or reject the request. If it accepts, a video streaming session is opened between the requesting device and the receiving device.

### BACKGROUND OF THE INVENTION

1. Field of the Invention

The present invention relates to streaming video. More particularly, the present invention relates to techniques for streaming video between handsets.

2. Background of the Invention

Mobile telephony today offers a wide variety of services. In the early days of mobile telephony, cellular telephones offered only basic voice communication services. As time passed and technology advanced, more services became available, such as text messaging. Today, users can send photographs and text messages using their cellular telephones. Users can also access the Internet. Even video sharing is possible.

However, cellular phone services still have a number of drawbacks. The goal of bringing all aspects of the Internet onto cell phones has not yet been satisfied. In particular, certain gaps still remain in the bridge between the formats and protocols underlying cellular phone technology and the formats and protocols underlying the Internet.

One area where gaps remain is video sharing. Cellular phones now offer the ability to share videos between two cellular phones in a process called video sharing (or video streaming). Similarly, two devices (or nodes) connecting over the Internet can also share videos using “peer to peer” technology.

Peer to peer networks are networks without clients or server. In the traditional “client-server” model, “client” computers request an action (such as transferring a file) from the server. The server, upon receiving the request, fulfills it, for example by transferring the requested file to the client. By contrast, in a peer to peer network, there are no clients and no servers. Computers (or, more generically, “nodes”) on the network communicate with one another equally. The lack of servers reduces the likelihood of bottlenecks, where multiple clients must wait for one server to respond to each client's request. Each node provides its own bandwidth, storing space, and computing power. As more nodes join the network, the network's capacity increases. This makes peer-to-peer networks especially useful when performing high-bandwidth tasks, such as streaming video.

However, present cellular phone technology does not permit mobile telephones (or handsets) to stream video using peer-to-peer technology. This limits the ability of cellular telephone users to fully enjoy all the advantages offered by the Internet and video sharing. What is needed is a way to permit cellular handsets to stream video using peer-to-peer networks.

### SUMMARY OF THE INVENTION

Current technologies for streaming video to mobile handsets are inefficient and inconvenient. Presently, handsets are capable of streaming video only between other handsets. Handsets are not capable of streaming video using peer-to-peer technologies. This limits the functionality of current mobile handsets.

In one exemplary embodiment, the present invention is a system for streaming video. The system includes a requesting device capable of transmitting a request to open a video stream. A server receives the requests and constructs a WAP Push command, which it sends to a receiving device. The receiving device receives the WAP push from the server and opens a video stream.

In another exemplary embodiment, the present invention is a system for streaming video. The system includes a requesting device capable of transmitting a request to open a video stream. A server receives the request and constructs a WAP Push. The server is capable of transmitting the WAP Push to a Push Proxy Gateway. The Push Proxy Gateway may forward the Push through a Short Messaging Service Center, which converts the Push into an SMS message if the receiving device is unable to receive the Push. The receiving device is capable of receiving the request and opening a video stream.

### BRIEF DESCRIPTION OF THE DRAWINGS

FIG. 1 shows a view of an environment according to an exemplary embodiment of the present invention.

FIG. 2 shows a view of a second environment according to an exemplary embodiment of the present invention.

### DETAILED DESCRIPTION OF THE INVENTION

The present invention provides for systems and methods for video streaming between handsets. Conventional technology only permits streaming between handsets or between two nodes in a peer-to-peer network. It does not permit a handset to stream video using peer-to-peer technology. This prevents cellular phone users from participating in peer-to-peer networks.

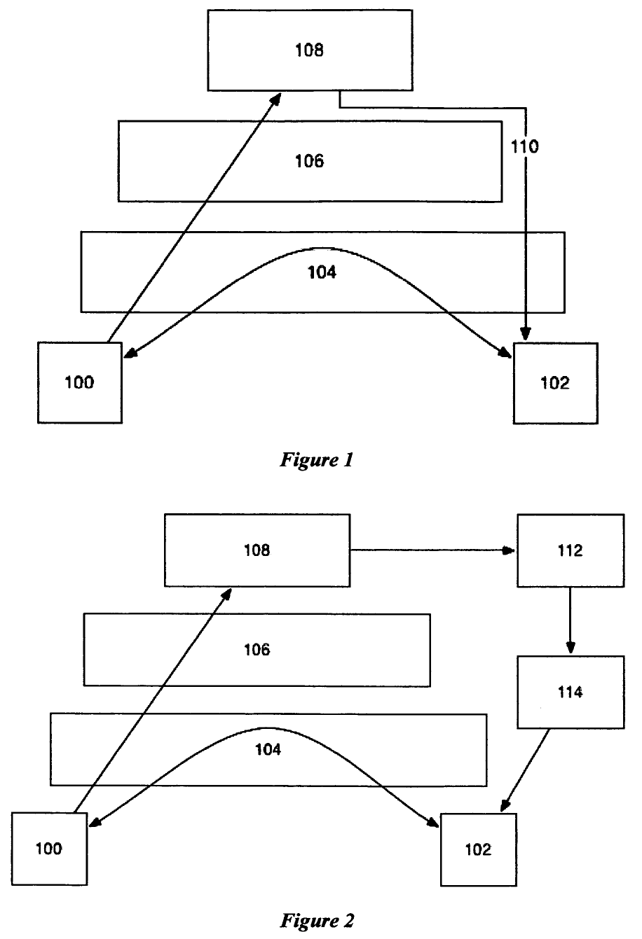

An exemplary embodiment of the present invention is shown in FIG. 1. Requesting device 100 would like to stream video to receiving device 102. Presently, however, there is no way for requesting device 100 to set up such a stream using a peer-to-peer network.

A solution according to the present invention is to place server 108 between requesting device 100 and receiving device 102. When the user of requesting device 100 wants to stream video to receiving device 102, receiving device 100 transmits a request to stream video to server 108. The request includes an identification of receiving device 102. The server receives the request and in turn sends a WAP Push command to receiving device 102. When receiving device receives the WAP Push, the receiving device may accept or deny the request. If the receiving device accepts the request, a video stream is created to stream video from the requesting device 100 to the receiving device 102.

The video stream may operate in one of two ways. The requesting device 102 could act as the “streaming server” for the video stream. Alternatively, the server 108 could perform this function. Server 108 may perform the streaming server function in situations where the video stream needs to be transcoded or buffered. This may occur where the receiving device must receive the video in a different format (requiring transcoding) or where the network is particularly congested with traffic (requiring buffering).

Server 108 transmits the request using a WAP Push 110, shown by the arrow 110 in FIG. 1. WAP Push 110 is a message to the receiving device 110 that includes an address of requesting device 100. Receiving device 102 may use the address to set up a video stream between requesting device 100 and receiving device 102. The use of the WAP Push permits the requesting device 100 to inform the receiving device 102 of the desire for the requesting device 100 to stream video to receiving device 102.

Generally, when a device wishes to receive streaming video, the device contacts the source of the streaming video and requests that the source stream video to the device. In peer-to-peer systems, the source will be another node on the network. The device “pulls” the stream from the source. In the context of normal peer-to-peer systems, this does not pose any difficulties due to the high bandwidth and availability present in most peer-to-peer systems.

“Pulling” is not suitable for the wireless context. Pulling requires the receiving device to poll the source to see if any new content is available. The increased network activity created by polling results in an inefficient use of wireless network resources. In addition, devices may not be always available to stream video upon request. Importantly, a device, such as requesting device 100, may wish to stream video to a receiving device 102. This reverses the normal situation—instead of a device asking to have video streamed to itself from another, the requesting device 100 is asking to have video streamed from itself to another. The WAP Push message assists the requesting device 100 by “pushing” the stream to receiving device 102. In this fashion receiving device need not be aware of requesting device 102 at the time the request is made.

FIG. 1 also displays two communication layers, first communication layer 104 and second communication layer 106. First communication layer 104 may be a mobile telephony communication layer permitting two mobile telephones to communicate with one another. This could be requesting device 100 and receiving device 102, though receiving device 102 may be any device capable of receiving streaming video. First communication layer 104 could be a mobile telephony standard such as Global System for Mobile Communications (GSM). The GSM standard offers high-quality communications at a lower cost than other standards. However, any known mobile telephony standard could be used as first communication layer 104.

Second communication layer 106 could use the IP Multimedia Subsystem standard (IMS). The IP Multimedia Subsystem (IMS) is a collection of functions and interfaces designed to enhance the mobile experience. IMS is specifically designed to be “transport agnostic”. Thus, IMS can work with any first communication layer 104, such as GMS or iDEN. Since IMS is transport agnostic, users from different networks can use IMS to communicate with one another, despite using networks that may otherwise be incompatible. As a result, users with one network can send E-mail, call, stream video, play on-line games, or use any other service with users from another network, without having to worry about what network each user is on.

IMS provides features not present in traditional mobile networks, such as the ability to determine the availability of users on the network. Currently, the only way to determine whether a user is available for a call is to call her. If the user is available, she will answer. If she is not, she will not answer, or the call may be forwarded to a voice mail service. With IMS, a user can see whether the person whom he wishes to call is available to take the call before punching in the number. This would reduce the “phone tag” problem.

IMS is also designed to handle applications that send large amounts of data. Communications layers such as GSM were originally designed to handle voice communications, not high-bandwidth data communications such as streaming video. Since IMS can handle high-bandwidth applications and services, IMS can be used to stream video from one user to another. As a result, IMS expands the usefulness of a user's mobile handset. IMS also uses existing protocols, such as SIP (Session Initiation Protocol) to set up, maintain, and terminate sessions; and RTSP (Real Time Streaming Protocol) to handle streaming data (such as streaming video). Some communications may not require the use of second communication layer 106. WAP Push 110 does not require IMS to function. Thus, as shown in FIG. 1, WAP Push 110 may be transmitted to receiving device 102 through first communications layer 104.

The request message sent from requesting device 100 to server 108 and contained within WAP Push 110 can be an SIP INVITE command. SIP (Session Initiation Protocol) is a protocol designed to initiate a session between two devices on a peer-to-peer network, where the session will be used to transfer media files. Real-time video streaming is one example of a situation where SIP can be used to set up a connection between two devices.

In basic operation, a device (such as requesting device 100) using SIP to initiate a session with another device (such as receiving device 102) sends a message with an INVITE command to the receiving device 102. The INVITE command “invites” the receiving device to create a session between requesting device 100 and receiving device 102. If the receiving device wishes to create a session, the receiving device 102 responds with an OK message. Requesting device 100 then responds to the OK with an ACK message. The session is opened after the requesting device issues the ACK message. In the case of the present invention the session will be used to stream video between requesting device 100 and receiving device 102. This can be done using any format or protocol. The Real Time Streaming Protocol (RTSP) may be used. RTSP is a protocol designed especially for streaming video. It contains commands useful in streaming video, such as “play”, “pause”, and “record”. However, RTSP is merely exemplary; any format or protocol may be used to accomplish the present invention.

For example, a husband may wish to stream video of his wife's participation in a triathlon to one (or more) of his friends. To do this, he enters into his mobile telephone an identification of the friend to whom he wishes to stream the video. The identification could be the friend's mobile telephone number. His mobile handset, the requesting device 100, then transmits the request, using first communication layer 102 and second communication layer 104, to server 108. Server 108 constructs a WAP Push command 110 and sends the command to the friend's receiving device 102. If the friend wishes to see the video, the friend accepts the request and a connection is formed between the husband's requesting device 100 and the friend's receiving device 102.

FIG. 2 shows a second embodiment of the present invention.

Requesting device 100 sends a request to stream video to server 108 through first communication layer 104 and second communication layer 106. However, server 108 communicates with receiving device 102 in an indirect fashion, as opposed to the direct fashion of the first embodiment (shown in FIG. 1).

The second embodiment, shown in FIG. 2, may be used when the receiving device 102 is not as sophisticated as requesting device 100, or in any situation where receiving device 102 may not be able to receive the WAP Push 110 (shown in FIG. 1) directly. Instead, the second embodiment makes use of a Push Proxy Gateway 112 and an SMSC (Short Messaging Service Center) 114.

Push Proxy Gateway 112 may be used to push a notification from server 108 to receiving device 102. Generally, a WAP proxy takes a command (or data packet) in one format or protocol and converts into a command (or data packet) in another format or protocol. The Push Proxy Gateway 112 takes the WAP Push sent from the server 108 and transforms it into an SMS (Short Message Service) message. SMS is a mature standard for sending text messages between mobile devices, supported by many mobile phones. Sending an SMS message from the Push Proxy Gateway 112 to receiving device 102 requires the use of a SMS Center (Short Message Service Center), such as SMSC 114. The SMSC receives the SMS from the Push Proxy Gateway and delivers it to receiving device 102 when receiving device 102 is available to receive messages. The SMSC can also deliver the message at any time. The SMS message could contain a SIP INVITE command, which receiving device responds to as described above with respect to the SIP protocol.

Once the SMSC sends the SMS to receiving device 102, receiving device can choose to accept the video stream or reject it. If the receiving device accepts the video stream, a stream is formed between requesting device 100 and receiving device 102. The video stream could operate using any protocol, such as RTSP (Real Time Streaming Protocol). As with the first embodiment described above, the server 108 can act as a streaming server and provide any necessary transcoding or buffering services. In this fashion, requesting device 100 may stream video to receiving device 102 regardless of receiving device 102's capabilities or the technology on which receiving device 102 is based. This could be most useful if requesting device 100 and receiving device 102 are not on the same network.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for streaming video, comprising:
a requesting device capable of transmitting a request to open a video stream;
a receiving device capable of receiving communications and opening a video stream between said requesting deice and said receiving device; and
a server capable of receiving the request from said requesting device and sending a WAP Push to a receiving device indicated in said request.

2. The system of claim 1, wherein the server acts as a streaming server and transcodes or buffers the video stream whenever transcoding or buffering is required.

3. The system of claim 1, wherein the system uses the IP Multimedia Subsystem.

4. The system of claim 1, wherein the request is transmitted and the video stream initiated using the Session Initiation Protocol.

5. The system of claim 1, wherein the requesting device is a video streaming handset.

6. The system of claim 1, wherein at least a portion of the system uses the Global System for Mobile Communications.

7. The system of claim 1, wherein the video is streamed using the Real Time Streaming Protocol.

8. A system for streaming video, comprising:
a requesting device capable of transmitting a request to open a video stream;
a receiving device capable of receiving communications and opening a video stream; and
a server capable of receiving the request from said requesting device and sending a WAP Push to the receiving device through a Push Proxy Gateway, wherein the Push Proxy Gateway forwards the request to the receiving device through a Short Messaging Service Center and the Short Message Servicing Center transmits the request to the receiving device by way of a Short Message Service message.

9. The system of claim 8, wherein the server acts as a streaming server and transcodes or buffers the video stream whenever transcoding or buffering is necessary.

10. The system of claim 8, wherein at least a portion of the system uses the IP Multimedia Subsystem.

11. The system of claim 8, wherein the request is transmitted and the video stream opened using the Session Initiation Protocol.

12. The system of claim 8, wherein the requesting device is a video streaming handset.

13. The system of claim 8, wherein at least a portion of the system uses the Global System for Mobile Communications.

14. The system of claim 8, wherein the video is streamed using the Real Time Streaming Protocol.

15. A method for streaming video, comprising the steps of:
transmitting a request to open a video stream from a requesting device;
receiving the request by an intermediate server;
transmitting a WAP Push from the intermediate server to a receiving device;
receiving the WAP Push by the receiving device; and
opening a video stream between the requesting device and the receiving device.

16. The method of claim 15, wherein the opening step further comprises opening a video stream between the requesting device and the receiving device via the intermediate server and the intermediate server performs steps of buffering and transcoding as needed.

17. The method of claim 15, wherein the method uses the IP Multimedia Subsystem.

18. The method of claim 15, wherein transmitting between the requesting device and the server and the opening step both use the Session Initiation Protocol.

19. The method of claim 15, wherein at least one of the steps are performed using the Global System for Mobile Communication.

20. The method of claim 15, further comprising the step of streaming video using the Real Time Streaming Protocol.
